(19) United States
(12) Patent Application Publication
(10) Pub. No.: US 2025/0293731 A1
(43) Pub. Date: Sep. 18, 2025

(54) PEAK TO AVERAGE POWER REDUCTION IN MULTIPLE INPUT MULTIPLE OUTPUT (MIMO) RADIO

(71) Applicant: Intel Corporation, Santa Clara, CA (US)

(72) Inventors: Thushara HEWAVITHANA, Tempe, AZ (US); Xiaowen ZHANG, Shanghai (CN); Zhangsheng XU, Shanghai (CN); Bishwarup MONDAL, San Ramon, CA (US); Yuwen LIU, Beijing (CN); Heng YE, Beijing (CN)

(21) Appl. No.: 18/861,231

(22) PCT Filed: Apr. 27, 2023
(86) PCT No.: PCT/US2023/020094

§ 371 Date: Oct. 29, 2024

(30) Foreign Application Priority Data
May 30, 2022 (WO) PCT/CN2022/096030

(51) Int. Cl. H04B 7/0413; H04L 27/26

(52) U.S. Cl. CPC H04B 7/0413; H04L 27/2614

(57) ABSTRACT

A wireless communication device comprising a processor, configured to determine a first signal corresponding to a resource block group; determine a phase shift; shift a second signal by the phase shift; control a transmitter to transmit the first signal and the phase shifted second signal during a transmission time corresponding to the resource block group.

### CROSS-REFERENCE TO RELATED APPLICATIONS

This is an international PCT Application, which claims priority to international PCT Application PCT/CN2022/096030, which was filed on May 30, 2022, the entirely of which is incorporated herein by reference.

### TECHNICAL FIELD

Aspects of this disclosure relate to the reduction of peak to average power for references signals in multiple input multiple output (MIMO) radio.

### BACKGROUND

Under 3^{rd} Generation Partnership Project (3GPP), 5G New radio (NR) Release 15 (3GPP NR Rel. 15), when multiple code division multiplexing (CDM) groups are in use, time domain signals corresponding to certain reference signals, such as the demodulation reference signal (DMRS) symbols, result in a higher Peak-to-Average-Power-Ratio (PAPR) compared to data symbols.

In Release 15, multiple CDM groups use the same CDM sequences. In a MIMO use case, if two transmission (TX) ports (layers) use corresponding sequences from the two CDM groups, this may result in coherent addition of layer time domain signals, thereby increasing peak signal level. Illustratively, and without limitation, when using demodulation reference signal (DMRS) Type 1, and for fewer than three layers, increased PAPR can be avoided by assigning the DMRS ports from the same CDM group. However, for greater than two layers, at least two CDM groups are required. The reference signals in these at least two CDM groups will be coherently added, thereby resulting in increased PAPR.

This coherent addition of layer time domain signals increases the PAPR of the overall signal going into power amplifiers. This may result in the DMRS symbols having approximately 3 dB greater PAPR compared to the data symbols (which are not coherently added). When faced with this increased PAPR, the power amplifier (PA) power (e.g. backing off of PA average power) can be reduced, which results in reduced coverage and difficulty in supporting higher order quadrature amplitude modulation (QAM) or Modulation and Coding (MCS) schemes, since these require higher SNR. Alternatively, if the PA is not reduced, then the PA will clip/distort the transmit signal, which will result in nonlinear distortion (e.g. induced distortion noise floor) that prevents the system from achieving higher order QAM and MCS. Thus, if not addressed, this increased PAPR imposes a severe limitation on 5G NR systems with respect to achieving high spectral efficiencies (SE).

### BRIEF SUMMARY OF THE DRAWINGS

FIG. 1 depicts a demodulation reference signal (DMRS) Configuration Type 1;

FIG. 2 depict simulation results for port 0 and port 2;

FIG. 3 shows an update process in which updated precoder weights are stored and reused in precoder step;

FIG. 4 depicts an application of the modified precoder;

FIG. 5 depicts the precoder weights for phase shift in a beamforming context;

FIG. 6 shows simulation results for 256QAM, 4 TX ports, type 1, 273 PRB, with a simulation time of 100 slots for the average PAPR gap between DMRS and data (dB);

FIG. 7 depicts an average PAPR gap between DMRS and DATA (dB), using a conventional CDD procedure, M=1;

FIG. 8 depicts the average PAPR gap between DMRS and DATA (dB) using modified CDD as described herein, with m=1

FIG. 9 depicts the modified CDD procedure with m=2. In this case, the PAPR is further reduced for PMI 3 and 4; and

FIG. 10 depicts the modified CDD procedure with m=4, with provides the full mitigation of DMRS PAPR, with DMRS PAPR always being lower than the data symbol PAPR;

FIG. 11 depicts a communication device according to an aspect of the disclosure;

FIG. 12 shows an example of a method.

### DETAILED DESCRIPTION

The following detailed description refers to the accompanying drawings that show, by way of illustration, specific details and aspects in which the disclosure may be practiced.

The word “exemplary” is used herein to mean “serving as an example, instance, or illustration”. Any aspect or design described herein as “exemplary” is not necessarily to be construed as preferred or advantageous over other aspects or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one. The terms “proper subset”, “reduced subset”, and “lesser subset” refer to a subset of a set that is not equal to the set, i.e. a subset of a set that contains less elements than the set.

As used herein, “memory” is understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

The term “terminal device” utilized herein refers to user-side devices (both portable and fixed) that can connect to a core network and/or external data networks via a radio access network. “Terminal device” can include any mobile or immobile wireless communication device, including User Equipment (UEs), Mobile Stations (MSs), Stations (STAs), cellular phones, tablets, laptops, personal computers, wearables, multimedia playback and other handheld or body-mounted electronic devices, consumer/home/office/commercial appliances, vehicles, and any other electronic device capable of user-side wireless communications. Without loss of generality, in some cases terminal devices can also include application-layer components, such as application processors or other general processing components that are directed to functionality other than wireless communications. Terminal devices can optionally support wired communications in addition to wireless communications. Furthermore, terminal devices can include vehicular communication devices that function as terminal devices.

The term “network access node” as utilized herein refers to a network-side device that provides a radio access network with which terminal devices can connect and exchange information with a core network and/or external data networks through the network access node. “Network access nodes” can include any type of base station or access point, including macro base stations, micro base stations, NodeBs, evolved NodeBs (eNBs), next Generation NodeBs (gNBs), Home base stations, Remote Radio Heads (RRHs), relay points, Wireless Local Area Network (WLAN) Access Points (APs), Bluetooth master devices, DSRC RSUs, terminal devices acting as network access nodes, and any other electronic device capable of network-side wireless communications, including both immobile and mobile devices (e.g., vehicular network access nodes, moving cells, and other movable network access nodes).

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” may encompass one or both of transmitting and receiving, i.e., unidirectional or bidirectional communication in one or both of the incoming and outgoing directions. The term “calculate” may encompass both ‘direct’ calculations via a mathematical expression/formula/relationship and ‘indirect’ calculations via lookup or hash tables and other array indexing or searching operations.

Various efforts have been made to avoid or mitigate the problem of coherent addition of CDM pilot signals resulting in increased PAPR.

One known solution to the increased PAPR resulting from the coherent addition of the CDM pilot signals is to utilize the base station's Error Vector Magnitude (EVM) budget to introduce controlled clipping in the digital time domain signal before the signal reaches the power amplifier. This results, however, in an undesirable EVM floor that may increase the difficulty in achieving a higher order quadrature amplitude modulation (QAM) scheme.

Another known solution to the increased PAPR resulting from the coherent addition of the CDM pilot signals is to apply different precoder values to the different resource block groups so that the full band does not have the same coherent sum. Although this may avoid the issue of increased PAPR discussed above, it precludes the use of optimal precoder values and thus results in a reduction of MIMO gains.

Another known solution to the increased PAPR resulting from the coherent addition of the CDM pilot signals is the introduction of cyclic delay diversity (CDD). In this manner, a linear phase shift is introduced across the bandwidth to the layers using a CDM group (e.g. the CDM pilot signals of one layer or transmission group are phase shifted or delayed in the time domain relative to the CDM pilot signals of another layer or transmission group) to induce a time offset (one sample or more), thereby misaligning the time domain signals of the various CDM groups time domain signals. Using this method, the signals CDM pilot signals of the layers are offset, thereby avoiding coherent addition of the same sample. This has undesired effect, however, of increasing the delay spread of the channel, which may be especially true for lower bandwidths. Thus, this method may limit the ability of a system to support certain QAM schemes (e.g. QAM256) having a high MCS in certain multipath channel scenarios. This also negatively affects the quasi colocation (QCL) property of the transmitted signal. Some user equipment (UEs) may assume QCL in processing the signal, which could lead to unexpected outcomes.

To avoid or reduce the negative consequences of the CDD solution, above, it is possible to capitalize on aspects of the 3GPP NR Rel. 15 standard to shift only CDM groups. That is, viewed in time domain, a delay may be introduced for a group of CDM pilot signals (e.g. for the second CDM group pilot signals). In particular, the delay includes a fixed phase shift in each PRB group, with different phase shifts from group to group. In this way, the problem of increased PAPR resulting from identical pilot signals in multiple transmission ports is mitigated by avoiding coherent addition.

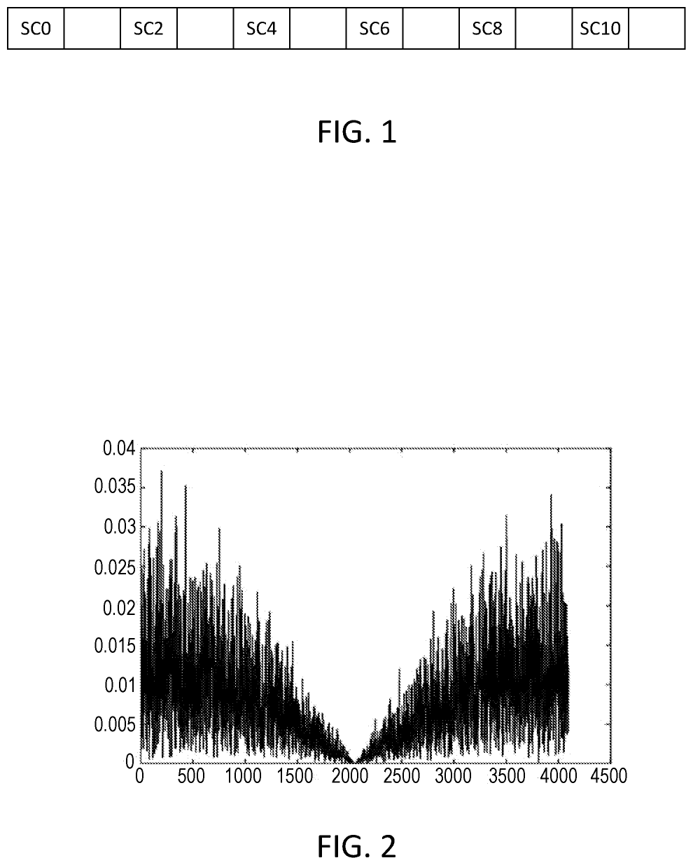

Without loss of generality, the principles and methods disclosed herein will be described with respect to a demodulation reference signal (DMRS) Configuration Type 1 and a transmission (Tx) port (or layer) assignment of 0-1 (e.g. corresponding to CDM group 1) and 2-3 (e.g. corresponding to CDM group 2), which is depicted in FIG. 1. As shown in this figure, the subcarrier indices 0, 2, 4, . . . are shared by Tx ports 0 and 1, and the subcarrier indices 1, 3, 5, . . . are shared by TX ports 2 and 3. In this configuration, however, the same pilot signals are repeated in the two sets of sub-carriers, which results in coherent addition of these pilot signals.

Illustratively, one may denote Layer 0 pilots in place correct frequency indices: X₀[0], 0, X₀[1], 0 . . . , X₀[N−1], 0, and denote Layer 2 pilots in place correct frequency indices: 0, X₀[0], 0, X₀[1], . . . , 0, X₀[N−1]. Note that 3GPP NR Rel. 15 reuses the same CDM sequence, which results in a shifted version of the same pilots. Although this was changed in in subsequent 3GPP releases, many operators continued to use 3GPP NR Rel. 15 as the basis for their network deployment. Thus, the principles and methods disclosed herein may benefit many existing operators. Illustratively, these principles may benefit implementations of FlexRAN to maintain compatibility with deployment requirements.

Continuing with the above signals for Layer 0 and Layer 2, the relationship between time domain signal for port 0, x₀(n), and port 2, x₂(n) is:

$${x}_{2} ( n ) = {x}_{0} ( n ) {e}^{j \frac{2 π n}{2 N}} \qquad ( 1 )$$

In a situation in which a wide band precoder with layers 0 and 2, in which layers 0 and 2 are combined by coefficients e^{jØ}^{₀} and e^{jØ}^{₂}, the combined signal becomes:

$${e}^{j {∅}_{0}} {x}_{0} ( n ) + {e}^{j {∅}_{2}} {x}_{0} ( n ) {e}^{j \frac{2 π n}{2 N}} = {x}_{0} ( n ) ( {e}^{j {∅}_{0}} + {e}^{j {∅}_{2}} {e}^{j \frac{2 π n}{2 N}} ) \qquad ( 2 )$$

As n varies, the term inside the brackets adds up perfectly coherently for

$$n = 2 N \frac{{∅}_{0} - {∅}_{2}}{2 π} .$$

Moreover, for a range of values around n, near coherent addition occurs. This coherent and/or near-coherent addition may result in an approximately 3 dB increase in PAPR for DMRS, assuming normal precoding. Moreover, a destructive addition of the time domain signal occurs for

$$n = mod ( N + 2 N \frac{{∅}_{0} - {∅}_{2}}{2 π} , 2 N ) .$$

The above is shown in simulation results for port 0 and port 2 signal addition given in FIG. 2.

As described above, CDD avoids this issue by introducing a linear phase slope across layer 2 to achieve a time delay in the time domain signal, so that the same samples do not align. To achieve an m sample delay for the layer 2 signal, for example, the phase slope applied as shown here:

$$0 , {X}_{0} [ 0 ] {e}^{- j \frac{2 π m}{2 N}} , 0 , {X}_{0} [ 1 ] {e}^{- j \frac{2 π3 m}{2 N}} , ... , 0 , {X}_{0} [ N - 1 ] {e}^{- j \frac{2 π ( 2 N - 1 ) m}{2 N}} \qquad ( 3 )$$

Hence the time domain signal for layer 2 now becomes,

$${x}_{2} ( n ) = {x}_{0} ( n - m ) {e}^{j \frac{2 π ( n - m )}{2 N}} \qquad ( 4 )$$

With this, there is no possibility of coherent addition of the same sample in the time domain for non-zero m. Nevertheless, and although the MIMO performance is not impacted by this CDD approach, the CDD approach is associated with several disadvantages. First, the CDD approach increases delay spread of the channel, which may be especially severe for lower bandwidths. For small bands, even m=1 can cause a significant delay spread increase. e.g. for 5 MHz band, one sample corresponds to 200 ns. Second, the CDD approach increases the inter signal interference (ISI) that is induced by the delay spread resulting from the CDD. This may limit the ability to support QAM256 with a high MCS. Third, the CDD approach has high computational complexity, as it requires the precoder to be phase shifted for every sub-carrier (resource element). Fourth, the CDD approach negatively affects the quasi co-location (QCL) property.

Most or all of the problems can be avoided, however, by applying the phase rotation based on groupings of the physical resource block (PRB), rather than for every sub-carrier or resource element. That is, phase rotation is applied on PRB group basis.

In this manner, a modified CDD method allows for the delay spread to be maintained over entire bandwidth, as a fixed phase shift is applied only within a PRB group. Otherwise stated, PRB groups (PRG) do not ‘see’ the delay spread. Using this modified CDD method, PAPR can be reduced without performance loss due to increased delay spread, as in CDD. Moreover, the resulting added complexity is an order of magnitude lower than with conventional CDD. Finally, the pre-coder performance is not negatively affected, and the QCL property not negatively affected within the PRG.

To describe the modified CDD method, N_{PRB} will be denoted as the number of PRBs in a PRB group (e.g. 2 PRBs or 4 PRBs). The phase rotation should be carefully calculated for the PRB group with the goal of obtaining a time shift in the time domain (in approximate sense) without the drawbacks of CDD.

The phasor for k'th PRB group can be shown as:

$${e}^{- j \frac{2 π mk ( 12 \times {N}_{PRB} )}{2 N}} , where k = 0 , 1 , … , \frac{2 N}{12 \times {N}_{PRB}} - 1 \qquad ( 5 )$$

With respect to the phasors for the layer 2 pilots, to obtain the length 2N phasor vector, the following calculations may be performed:
First, 12×N_{PRB}−1 zeros may be inserted between each phasor to generate a zero inserted 2N sequence. The time domain signal for this is δ(t−m)+δ(t−12×N_{PRB}−m)+ . . . .
Next, a cyclic convolution may be performed with a square function of width 12×N_{PRB} frequency bins. Time domain function for the square function is the sinc function with the main lobe width of 12×N_{PRB} samples.
This time domain product of delta function sequence and sync function leads to one dominant delta function δ(t−m) for small m, and the other terms are suppressed

For example, with a narrow band channel having 28 PRB bandwidth (10 MHz with μ=1 numerology), and assuming m=1, there is one dominant peak, δ(t−1). i.e. the impulse at time t=1.

Thus, using this technique, the layer two pilots in time domain form m sample delay, as with the CDD case, and therefore the increased PAPR resulting for coherent addition is mitigated, as with the conventional CDD approach. However, when viewed within the individual PRB groups in frequency, the phase shift is constant and therefore there is no lengthening of the impulse response of the channel (when estimated per PRB group basis).

In fact, it is possible to use other than m=1, i.e. 4, 8 etc, to check where larger ‘delay’ can help mitigate PAPR better. This is possible because the procedure does not really increase the delay as far as individual PRB groups are concerned, and therefore there is no performance impact.

Implementation of the Algorithm with the Pre-Coder

In case of a wide band precoder, the columns of the precoder matrix corresponding to layer 2 and 3 may be multiplied with the phase rotation described above. Again, this phase rotation is specified per PRB group. Hence, the multiplications need only be performed once per PRB group.

In case of sub-band precoding, the same method is followed. i.e. constant phase rotation per PRB group.

Since the same phasor is applied to a column (i.e. weights for a given layer), the performance of the precoder is not impacted at all. Thus, this modified CDD approach does not negatively affect the ability to achieve QAM256 with high MCS with the proper precoder.

The implementation of the modified CDD procedure can be performed in two steps.

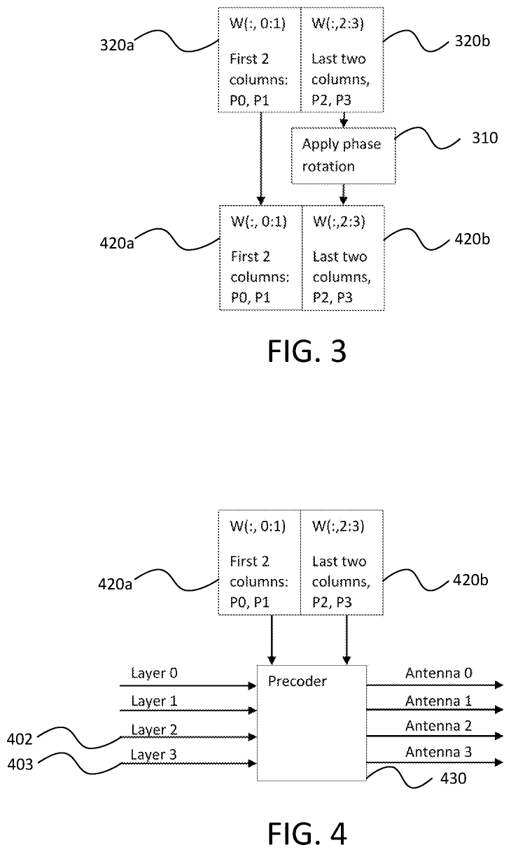

Step 1: Modify the precoder matrix to absorb the phase rotations as shown in FIG. 3. In standard precoding (note that a standard precoding procedure is depicted as FIG. 4), the signal is multiplied by a precoding matrix 420a-b, wherein the weights of the precoding matrix 420a-b may be selected based on the channel, the beamforming requirements, or otherwise. In an exemplary configuration using four antennas as depicted in FIG. 4, the precoding matrix 420a-b may be a 4×4 matrix. Any known technique may be utilized to optimize the precoding matrix.

Once the desired precoding matrix 320a-b is determined, the precoding matrix can be altered to reflect the desired phase shift. This is depicted in an exemplary configuration in FIG. 3, in which the 4×4 precoding matrix 320a-b consists of 4 columns (0 through 3, 0 and 1 320a and 2 and 3 320b), and in which the phase shift is multiplied with columns 2 and 3 320b to create a modified precoding matrix 420a-b. Otherwise stated, columns 2, and 3 320b are multiplied by the phasor calculated as in the equation (5). This is computationally more efficient than having to apply the phase rotation 310 to all the sub-carriers in Layer 2 402 and 3 403. FIG. 3 shows the update process in which the updated precoder weights 420a-b are stored and reused in precoder 430 step.

In case of conventional CDD, the pre-coder needs to be updated for each subcarrier location. i.e. 12×N_{PRB} times for PRB group. In the modified CDD procedure as disclosed herein, the update only happens once per N_{PRB} PRBs.

Step 2: To apply the precoder, the above modified precoder matrices 420a-b are applied to subcarrier data—the same precoder gets applied throughput the slot (14 symbols). FIG. 4 depicts the application of the modified precoder.

Additional complexity (CMUL count) as a percentage of current precoder complexity is shown below:

| Algorithm | Pre-process | Apply Precoder | Percentage increase |
|---|---|---|---|
| CDD | phase rotate layer data: 14 × 12N_{PRB} × 2 | 14 × 12N_{PRB} × 4 × 4 | $\frac{1}{8} = 12.5 \%$ |
| Modified CDD | phase rotate precoder: 14 × 2 × 4 | 14 × 12N_{PRB} × 4 × 4 | $\frac{1}{2 \times 12 {N}_{PRB}} = 2 \% ( for {N}_{PRB} = 2 )$ |

Conventional CDD adds 12.5% additional complexity tote precoder. Some additional computational resources may be required to calculate the phase rotations needed for precoder update. In contrast, the complexity of modified CDD is lower. For example, for a 2 PRB block size, the added complexity is 2%.

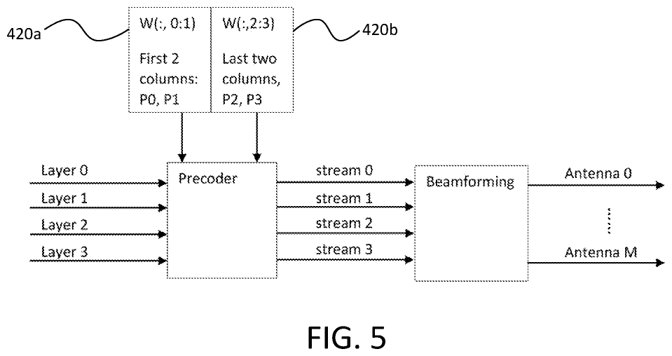

FIG. 4 and FIG. 5 show the modified CDD when deployed to modify the precoder weights 420a-b to effectively delay the time samples of layers with matching DMRS pilots relative to one another. This can help mitigate the PAPR issue regardless of whether there is a Beamformer to follow.

As described above, the modified CDD procedure applies a constant phase rotation within a group of PRBs (e.g. with a PRG). The phase only changes from PRG to PRG, but not within a single PRG. Of note, Section 5.1.2.3 of 38.214 within 3GPP NR Rel. describes PRB bundling and has features that enable implementation of the modified CDD approach. Specifically, the standard states that “The UE may assume the same precoding is applied for any downlink contiguous allocation of PRBs in a PRG”. By default, PRG size is 2 PRBs. In the absence of any configuration info (e.g., through downlink control information (DCI)) from base station (BS), the user equipment (UE) has to assume that a PRG consists of 2 PRBs and that the precoder is the same within the bundles of 2 PRB, but that the precoding can differ from bundle to bundle.

The standard also permits the BS to set the PRG size. That is, the BS can inform the UE that each PRG consists of 2 or more PRBs. The BS can theoretically select any number of PRBs in a PRG. The BS can select a number of PRB in a PRG for the duration of its transmission to the UE. Alternatively, the BS can dynamically select a number of PRBs in a PRG.

### Simulation Results

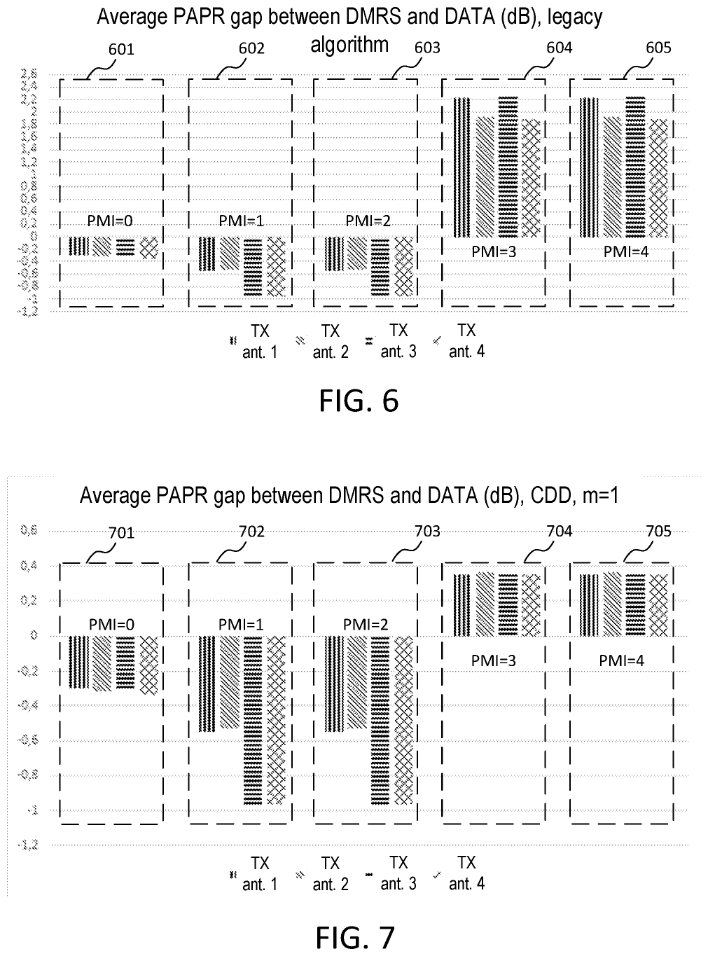

FIG. 6 shows simulation results for 256QAM, 4 TX ports, type 1, 273 PRB, with a simulation time of 100 slots for the average PAPR gap between DMRS and data (dB). For the legacy algorithm, PAPR is not fully mitigated for all PML PMI 3 and 4 still has significantly high PAPR gap (>2 dB) between DMRS symbols and data symbols. Note that this figure shows five clusters 601-605 of results, from left to right, with each cluster having four entries representing PAPR for a given precoding matrix indicator (PMI). The first cluster 601 represents PMI=0; the second cluster 602 represents PMI=1; the third cluster 603 represents PMI=2; the fourth cluster 604 represents PMI=3; and the fifth cluster 605 represents PMI=4. For each cluster, the first result (e.g. the first bar at the left hand side) represents Tx antenna 1, the second result represents Tx antenna 2, the third result represents Tx antenna 3, and the fourth result represents Tx antenna 4.

FIG. 7 depicts an average PAPR gap between DMRS and DATA (dB), using a conventional CDD procedure, M=1. For the CDD procedure, a minimum possible m value of 1 is used. PAPR is not fully mitigated for all PML PMI 3 and 4 still has ˜0.5 dB higher PAPR compared to the data symbols. In addition, the performance of high order QAM may be negatively affected due to increased delay spread. The first cluster 701 represents PMI=0; the second cluster 702 represents PMI=1; the third cluster 703 represents PMI=2; the fourth cluster 704 represents PMI=3; and the fifth cluster 705 represents PMI=4. For each cluster, the first result (e.g. the first bar at the left hand side) represents Tx antenna 1, the second result represents Tx antenna 2, the third result represents Tx antenna 3, and the fourth result represents Tx antenna 4.

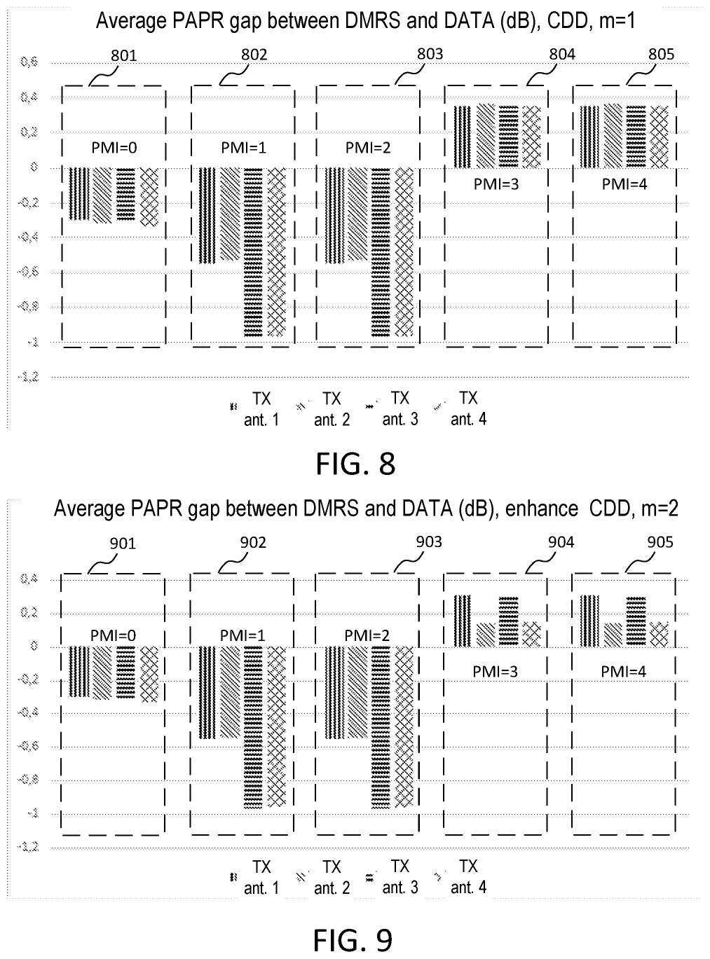

FIG. 8 depicts the average PAPR gap between DMRS and DATA (dB) using modified CDD as described herein, with m=1. Using this modified CDD procedure, larger m values can be used, thus further mitigating the PAPR, while not negatively affecting performance. It can be seen that m=1 yields similar results to conventional CDD, as would be expected. The first cluster 801 represents PMI=0; the second cluster 802 represents PMI=1; the third cluster 803 represents PMI=2; the fourth cluster 804 represents PMI=3; and the fifth cluster 805 represents PMI=4. For each cluster, the first result (e.g. the first bar at the left hand side) represents Tx antenna 1, the second result represents Tx antenna 2, the third result represents Tx antenna 3, and the fourth result represents Tx antenna 4.

FIG. 9 depicts the modified CDD procedure with m=2. In this case, the PAPR is further reduced for PMI 3 and 4. The first cluster 901 represents PMI=0; the second cluster 902 represents PMI=1; the third cluster 903 represents PMI=2; the fourth cluster 904 represents PMI=3; and the fifth cluster 905 represents PMI=4. For each cluster, the first result (e.g. the first bar at the left hand side) represents Tx antenna 1, the second result represents Tx antenna 2, the third result represents Tx antenna 3, and the fourth result represents Tx antenna 4.

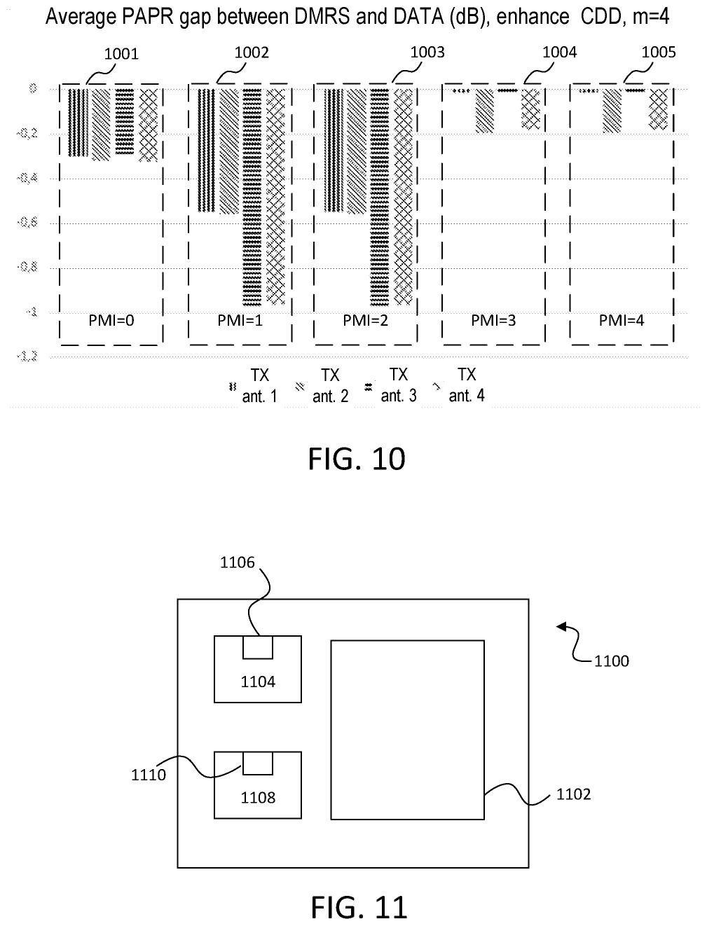

FIG. 10 depicts the modified CDD procedure with m=4, with provides the full mitigation of DMRS PAPR, with DR-MS PAPR always being lower than the data symbol PAPR. The first cluster 1001 represents PMI=0; the second cluster 1002 represents PMI=1; the third cluster 1003 represents PMI=2; the fourth cluster 1004 represents PMI=3; and the fifth cluster 1005 represents PMI=4. For each cluster, the first result (e.g. the first bar at the left hand side) represents Tx antenna 1, the second result represents Tx antenna 2, the third result represents Tx antenna 3, and the fourth result represents Tx antenna 4.

FIG. 11 depicts a wireless communication device 1100 according to an aspect of the disclosure. The device may include a processor 1102, a first baseband modem 1104, a first transceiver or transmitter (which may be part of the first baseband modem) 1106, a second baseband modem 1108, a second transceiver or transmitter (which may be part of the second baseband modem) 1110. The processor may be configured to determine a first signal corresponding to a resource block group, wherein the first signal includes a reference symbol; control a transmitter to transmit the first signal during a transmission time corresponding to the resource block group; determine a phase shift; shift a second signal including the reference symbol by the phase shift; and control the transmitter to transmit the phase shifted second signal during the transmission time corresponding to the resource block group. This device may be configured to perform any of the functions in the examples below.

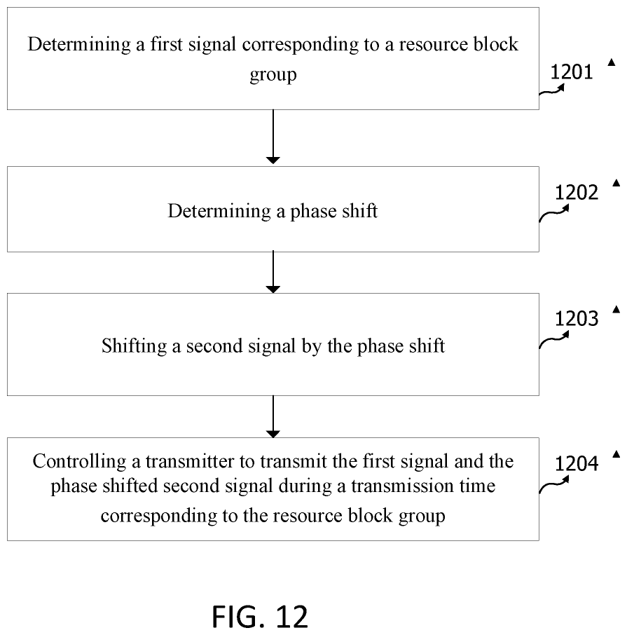

FIG. 12 shows an example of a method of wireless communication, the method including: determining 1201 a first signal corresponding to a resource block group; determining 1202 a phase shift; shifting 1203 a second signal by the phase shift; and controlling 1204 a transmitter to transmit the first signal and the phase shifted second signal during a transmission time corresponding to the resource block group.

Additionally or alternatively, any aspect of this disclosure may be implemented as a non-transitory computer readable medium, including instructions which, if executed, cause one or more processors to perform any method of the examples below.

Additional aspects of the disclosure will be shown below by example:

In Example 1, a wireless communication device including a processor, configured to determine a first signal corresponding to a resource block group; determine a phase shift; shift a second signal by the phase shift; control a transmitter to transmit the first signal and the phase shifted second signal during a transmission time corresponding to the resource block group.

In Example 2, the wireless communication device of Example 1, wherein the first signal includes a first reference symbol and the second symbol includes a second reference symbol.

In Example 3, the wireless communication device of Example 2, wherein the reference symbol of the first signal has a symbol number with a transmission frame, and wherein the reference symbol of the second signal has a same symbol number within the transmission frame as the reference symbol of the first signal.

In Example 4, the wireless communication device of any one of Examples 1 to 3, further including determining a first precoding matrix, and precoding the first signal according to the first precoding matrix.

In Example 5, the wireless communication device of Example 4, wherein controlling the transmitter to transmit the first signal includes controlling the transmitter to transmit the precoded first signal.

In Example 6, the wireless communication device of any one of Examples 1 to 5, further including determining a second precoding matrix, wherein the second precoding matrix is configured to shift the second signal by the phase shift when the second signal is precoded according to the second precoding matrix; wherein shifting the second signal by the phase shift and controlling the transmitter to transmit the phase shifted second signal includes precoding the second signal by the second precoding matrix and controlling the transmitter to transmit the precoded second signal.

In Example 7, the wireless communication device of any one of Examples 1 to 6, wherein the processor is configured to operate according to a code division multiplexing scheme.

In Example 8, the wireless communication device of any one of Examples 1 to 7, wherein the first reference symbol and the second reference symbol are symbols for a Demodulation Reference Signal.

In Example 9, the wireless communication device of any one of Examples 1 to 8, wherein the first signal and the second signal are signals according to the according to the 3rd Generation Partnership Project (3GPP), New Radio, Release 15.

In Example 10, the wireless communication device of any one of Examples 1 to 9, wherein the first reference symbol is assigned a first transmission time according to the 3rd Generation Partnership Project (3GPP), New Radio, Release 15 (3GPP Rel. 15) scheme; wherein the second reference symbol is assigned a second transmission time according to the 3GPP Rel. 15; and wherein the first transmission time and the second transmission time are concurrent.

In Example 11, the wireless communication device of any one of Examples 1 to 10, wherein the resource block group is a first resource block group; wherein the reference symbol is a first reference symbol; wherein the phase shift is a first phase shift; and wherein the processor is further configured to determine a third signal corresponding to second resource block group, adjacent to the first resource block group, wherein the third signal includes a second reference symbol; determine a second phase shift, different from the first phase shift; shift a fourth signal including the second reference symbol by the second phase shift; and control the transmitter to transmit the third signal and the phase shifted fourth signal during the transmission time corresponding to the second resource block group.

In Example 12, the wireless communication device of Example 11, wherein the processor shifting the second signal and/or the fourth signal includes the processor applying physical resource group specific weights during precoding.

In Example 13, the wireless communication device of Example 11 or 12, wherein the processor determining the first phase shift includes the processor determining a first constant phase shift for the first resource block group, and wherein the processor determining the second phase shift includes the processor determining a second constant phase shift, different from the first constant phase shift, for the second block group.

In Example 14, the wireless communication device of any one of Examples 11 to 13, further including a precoder, configured to receive a signal, apply one or more precoding weights to the signal, and output a precoded signal as the signal to which the precoding weights were applied; wherein the processor is configured to shift the second signal and/or the fourth signal by controlling the precoder to apply physical resource group specific weights during precoding.

In Example 15, the wireless communication device of any one of Examples 1 to 14, wherein the physical resource block group includes a plurality of subcarriers, and wherein the processor is configured to control the transmitter to transmit data on each subcarrier of the plurality of subcarriers in the physical resource block group according to the determined phase shift.

In Example 16, a non-transitory computer readable medium, including instructions which, if executed, cause a processor to: determine a first signal corresponding to a resource block group; determine a phase shift; shift a second signal by the phase shift; control a transmitter to transmit the first signal and the phase shifted second signal during a transmission time corresponding to the resource block group.

In Example 17, the non-transitory computer readable medium of Example 16, wherein the first signal includes a first reference symbol and the second symbol includes a second reference symbol.

In Example 18, the non-transitory computer readable medium of Example 17, wherein the reference symbol of the first signal has a symbol number with a transmission frame, and wherein the reference symbol of the second signal has a same symbol number within the transmission frame as the reference symbol of the first signal.

In Example 19, the non-transitory computer readable medium of any one of Examples 16 to 18, wherein the instructions are further configured to cause the processor to determine a first precoding matrix, and precoding the first signal according to the first precoding matrix.

In Example 20, the non-transitory computer readable medium of Example 19, wherein controlling the transmitter to transmit the first signal includes controlling the transmitter to transmit the precoded first signal.

In Example 21, the non-transitory computer readable medium of any one of Examples 16 to 20, wherein the instructions are further configured to cause the processor to determine a second precoding matrix, wherein the second precoding matrix is configured to shift the second signal by the phase shift when the second signal is precoded according to the second precoding matrix; wherein shifting the second signal by the phase shift and controlling the transmitter to transmit the phase shifted second signal includes precoding the second signal by the second precoding matrix and controlling the transmitter to transmit the precoded second signal.

In Example 22, the non-transitory computer readable medium of any one of Examples 16 to 21, wherein the instructions are configured to cause the processor to operate according to a code division multiplexing scheme.

In Example 23, the non-transitory computer readable medium of any one of Examples 16 to 22, wherein the first reference symbol and the second reference symbol are symbols for a Demodulation Reference Signal.

In Example 24, the non-transitory computer readable medium of any one of Examples 16 to 23, wherein the first signal and the second signal are signals according to the according to the 3rd Generation Partnership Project (3GPP), New Radio, Release 15.

In Example 25, the non-transitory computer readable medium of any one of Examples 16 to 24, wherein the first reference symbol is assigned a first transmission time according to the 3rd Generation Partnership Project (3GPP), New Radio, Release 15 (3GPP Rel. 15) scheme; wherein the second reference symbol is assigned a second transmission time according to the 3GPP Rel. 15; and wherein the first transmission time and the second transmission time are concurrent.

In Example 26, the non-transitory computer readable medium of any one of Examples 16 to 25, wherein the resource block group is a first resource block group; wherein the reference symbol is a first reference symbol; wherein the phase shift is a first phase shift; and wherein the processor is further configured to: determine a third signal corresponding to second resource block group, adjacent to the first resource block group, wherein the third signal includes a second reference symbol; determine a second phase shift, different from the first phase shift; shift a fourth signal including the second reference symbol by the second phase shift; and control the transmitter to transmit the third signal and the phase shifted fourth signal during the transmission time corresponding to the second resource block group.

In Example 27, the non-transitory computer readable medium of Example 26, wherein the processor shifting the second signal and/or the fourth signal includes the processor applying physical resource group specific weights during precoding.

In Example 28, the non-transitory computer readable medium of Example 26 or 27, wherein the processor determining the first phase shift includes the processor determining a first constant phase shift for the first resource block group, and wherein the processor determining the second phase shift includes the processor determining a second constant phase shift, different from the first constant phase shift, for the second block group.

In Example 29, the non-transitory computer readable medium of any one of Examples 26 to 28, further including a precoder, configured to receive a signal, apply one or more precoding weights to the signal, and output a precoded signal as the signal to which the precoding weights were applied; wherein the processor is configured to shift the second signal and/or the fourth signal by controlling the precoder to apply physical resource group specific weights during precoding.

In Example 30, the non-transitory computer readable medium of any one of Examples 16 to 29, wherein the physical resource block group includes a plurality of subcarriers, and wherein the processor is configured to control the transmitter to transmit data on each subcarrier of the plurality of subcarriers in the physical resource block group according to the determined phase shift.

In Example 31, a method of wireless communication including: determining a first signal corresponding to a resource block group; determining a phase shift; shifting a second signal by the phase shift; controlling a transmitter to transmit the first signal and the phase shifted second signal during a transmission time corresponding to the resource block group.

In Example 32, the method of wireless communication of Example 31, wherein the first signal includes a first reference symbol and the second symbol includes a second reference symbol.

In Example 33, the method of wireless communication of Example 32, wherein the reference symbol of the first signal has a symbol number with a transmission frame, and wherein the reference symbol of the second signal has a same symbol number within the transmission frame as the reference symbol of the first signal.

In Example 34, the method of wireless communication of any one of Examples 31 to 33, further including determining a first precoding matrix, and precoding the first signal according to the first precoding matrix.

In Example 35, the method of wireless communication of Example 34, wherein controlling the transmitter to transmit the first signal includes controlling the transmitter to transmit the precoded first signal.

In Example 36, the method of wireless communication of any one of Examples 31 to 35, further including determining a second precoding matrix, wherein the second precoding matrix is configured to shift the second signal by the phase shift when the second signal is precoded according to the second precoding matrix; wherein shifting the second signal by the phase shift and controlling the transmitter to transmit the phase shifted second signal includes precoding the second signal by the second precoding matrix and controlling the transmitter to transmit the precoded second signal.

In Example 37, the method of wireless communication of any one of Examples 31 to 36, further including operating according to a code division multiplexing scheme.

In Example 38, the method of wireless communication of any one of Examples 31 to 37, wherein the first reference symbol and the second reference symbol are symbols for a Demodulation Reference Signal.

In Example 39, the method of wireless communication of any one of Examples 31 to 38, wherein the first signal and the second signal are signals according to the according to the 3rd Generation Partnership Project (3GPP), New Radio, Release 15.

In Example 40, the method of wireless communication of any one of Examples 31 to 39, wherein the first reference symbol is assigned a first transmission time according to the 3rd Generation Partnership Project (3GPP), New Radio, Release 15 (3GPP Rel. 15) scheme; wherein the second reference symbol is assigned a second transmission time according to the 3GPP Rel. 15; and wherein the first transmission time and the second transmission time are concurrent.

In Example 41, the method of wireless communication of any one of Examples 31 to 40, wherein the resource block group is a first resource block group; wherein the reference symbol is a first reference symbol; wherein the phase shift is a first phase shift; and further including: determining a third signal corresponding to second resource block group, adjacent to the first resource block group, wherein the third signal includes a second reference symbol; determining a second phase shift, different from the first phase shift; shifting a fourth signal including the second reference symbol by the second phase shift; and controlling the transmitter to transmit the third signal and the phase shifted fourth signal during the transmission time corresponding to the second resource block group.

In Example 42, the method of wireless communication of Example 41, wherein the shifting the second signal and/or the fourth signal includes the applying physical resource group specific weights during precoding.

In Example 43, the method of wireless communication of Example 41 or 42, wherein determining the first phase shift includes the processor determining a first constant phase shift for the first resource block group, and wherein determining the second phase shift includes the processor determining a second constant phase shift, different from the first constant phase shift, for the second block group.

In Example 44, the method of wireless communication of any one of Examples 41 to 43, further including a precoder, configured to receive a signal, apply one or more precoding weights to the signal, and output a precoded signal as the signal to which the precoding weights were applied; wherein the processor is configured to shift the second signal and/or the fourth signal by controlling the precoder to apply physical resource group specific weights during precoding.

In Example 45, the method of wireless communication of any one of Examples 31 to 44, wherein the physical resource block group includes a plurality of subcarriers, and further including controlling the transmitter to transmit data on each subcarrier of the plurality of subcarriers in the physical resource block group according to the determined phase shift.

In Example 46, the wireless communication device of any one of Examples 1 to 15, wherein the second signal corresponds to the resource block group.

In Example 47, the wireless communication device of any one of Examples provided herein (e.g. Example 46), wherein the first signal is for a first CDM group and the second signal is for a second CDM group.

In Example 48, the wireless communication device of any one of Examples provided herein (e.g. any one of Examples 46 to 47), wherein the first signal is assigned to a first and a second transmission (Tx) port and the second signal is assigned to a third and a fourth TX port.

In Example 49, the wireless communication device of any one of Examples provided herein (e.g. any one of Examples 46 to 48), wherein the first signal comprises pilot signals and the second signal comprises the same pilot signals.

In Example 50, the wireless communication device of any one of Examples provided herein (e.g. any one of Examples 46 to 49), wherein the second signal is shifted with a phasor of

$${e}^{- j \frac{2 π mk ′ ( 12 \times {N}_{PRB} )}{2 N}}$$

for k′-th physical resource block group of a number of physical resource block groups, each physical resource block group comprising N_{PRB} number of physical resource blocks, wherein k is the number of physical resource block groups between

$$0 and \frac{2 N}{12 \times {N}_{PRB}} - 1 ,$$

and wherein m represents a sample delay which may be an integer comprising one of 1, 4, or 8.

In Example 51, the wireless communication device of any one of Examples provided herein (e.g. Example 50), wherein the second signal is shifted by applying a phase rotation corresponding to the resource block group to columns of a predetermined precoding matrix, which the columns correspond to the second signal.

In Example 52, the wireless communication device of any one of Examples provided herein (e.g. Example 51), wherein the predetermined precoding matrix is multiplied by the phasor to obtain a second precoding matrix to be applied to the second signal for the transmission.

In Example 53, the non-transitory computer readable medium of any one of Examples 16 to 30, wherein the second signal corresponds to the resource block group.

In Example 54, the non-transitory computer readable medium of any one of Examples provided herein (e.g. Example 53), wherein the first signal is for a first CDM group and the second signal is for a second CDM group.

In Example 55, the non-transitory computer readable medium of any one of Examples provided herein (e.g. any one of Examples 53 to 54), wherein the first signal is assigned to a first and a second transmission (Tx) port and the second signal is assigned to a third and a fourth TX port.

In Example 56, the non-transitory computer readable medium of any one of Examples provided herein (e.g. any one of Examples 53 to 55), wherein the first signal comprises pilot signals and the second signal comprises the same pilot signals.

In Example 57, the non-transitory computer readable medium of any one of Examples provided herein (e.g. any one of Examples 53 to 56) wherein the second signal is shifted with a phasor of

$${e}^{- j \frac{2 π mk ′ ( 12 \times {N}_{PRB} )}{2 N}}$$

for k′-th physical resource block group of a number of physical resource block groups, each physical resource block group comprising N_{PRB} number of physical resource blocks, wherein k is the number of physical resource block groups between

$$0 and \frac{2 N}{12 \times {N}_{PRB}} - 1 ,$$

and wherein m represents a sample delay which may be an integer comprising one of 1, 4, or 8.

In Example 58, the non-transitory computer readable medium of any one of Examples provided herein (e.g. Example 57), wherein the second signal is shifted by applying a phase rotation corresponding to the resource block group to columns of a predetermined precoding matrix, which the columns correspond to the second signal.

In Example 59, the non-transitory computer readable medium of any one of Examples provided herein (e.g. Example 58), wherein the predetermined precoding matrix is multiplied by the phasor to obtain a second precoding matrix to be applied to the second signal for the transmission.

In Example 60, the method of wireless communication of any one of Examples 31 to 45, wherein the second signal corresponds to the resource block group.

In Example 61, the method of wireless communication of any one of Examples provided herein (e.g. Example 60), wherein the first signal is for a first CDM group and the second signal is for a second CDM group.

In Example 62, the method of wireless communication of any one of Examples provided herein (e.g. any one of Examples 60 to 61), wherein the first signal is assigned to a first and a second transmission (Tx) port and the second signal is assigned to a third and a fourth TX port.

In Example 63, the method of wireless communication of any one of Examples provided herein (e.g. any one of Examples 60 to 62), wherein the first signal comprises pilot signals and the second signal comprises the same pilot signals.

In Example 64, the method of wireless communication of any one of Examples provided herein (e.g. any one of Examples 60 to 63) wherein the second signal is shifted with a phasor of

$${e}^{- j \frac{2 π mk ′ ( 12 \times {N}_{PRB} )}{2 N}}$$

for k′-th physical resource block group of a number of physical resource block groups, each physical resource block group comprising N_{PRB} number of physical resource blocks, wherein k is the number of physical resource block groups between

$$0 and \frac{2 N}{12 \times {N}_{PRB}} - 1 ,$$

and wherein m represents a sample delay which may be an integer comprising one of 1, 4, or 8.

In Example 65, the method of wireless communication of any one of Examples provided herein (e.g. Example 64), wherein the second signal is shifted by applying a phase rotation corresponding to the resource block group to columns of a predetermined precoding matrix, which the columns correspond to the second signal.

In Example 66, the method of wireless communication of any one of Examples provided herein (e.g. Example 65), wherein the predetermined precoding matrix is multiplied by the phasor to obtain a second precoding matrix to be applied to the second signal for the transmission.

In Example 67, a wireless communication device including: a processor, configured to: determine a first signal corresponding to a resource block group; determine a first precoding matrix for the first signal; precode the first signal according to the first precoding matrix; determine a second signal corresponding to the resource block group; determine a second precoding matrix for the second signal; determine a phase shift; modify the second precoding matrix by values representing the phase shift; precode the second signal according to the modified second precoding matrix. The processor may further be configured to control a transmitter to transmit the precoded first signal and the precoded second signal.

In Example 68, the wireless communication device of Example 67, wherein the first signal comprises a first reference symbol and the second symbol comprises a second reference symbol.

In Example 69, the wireless communication device of Example 68, wherein the reference symbol of the first signal has a symbol number with a transmission frame, and wherein the reference symbol of the second signal has a same symbol number within the transmission frame as the reference symbol of the first signal.

In Example 70, the wireless communication device of Example 68 or 69 wherein the processor is configured to control the transmitter to send the first precoded signal and the second precoded signal concurrently.

In Example 71, the wireless communication device of any one of Examples 67 to 70, wherein modifying the second precoding matrix by values representing the phase shift comprises multiplying fewer than all columns of the precoding matrix by values representing the phase shift.

In Example 72, the wireless communication device of Example 71, wherein the second precoding matrix is a 4 by 4 matrix, and wherein modifying the second precoding matrix by values representing the phase shift comprises modifying 3rd and 4th columns of the second precoding matrix by values representing the phase shift.

In Example 73, the wireless communication device of any one of Examples 67 to 72, wherein controlling the transmitter to transmit the precoded first signal and the precoded second signal comprises transmitting a sum of the precoded first signal and the precoded second signal.

In Example 74, the wireless communication device of any one of Examples 67 to 73, wherein the processor is configured to operate according to a code division multiplexing scheme.

In Example 75, the wireless communication device of any one of Examples 67 to 74, wherein the first reference symbol and the second reference symbol are symbols for a Demodulation Reference Signal.

In Example 76, the wireless communication device of any one of Examples 67 to 75, wherein the first signal and the second signal are signals according to the according to the 3rd Generation Partnership Project (3GPP), New Radio, Release 15.

In Example 77, the wireless communication device of any one of Examples 67 to 76, wherein the first reference symbol is assigned a first transmission time according to the 3rd Generation Partnership Project (3GPP), New Radio, Release 15 (3GPP Rel. 15) scheme; wherein the second reference symbol is assigned a second transmission time according to the 3GPP Rel. 15; and wherein the first transmission time and the second transmission time are concurrent.

DMRS Type 1 may refer to a particular type of demodulation reference signals used in wireless communication systems such as 5G New Radio (NR). DMRS is used to facilitate channel estimation and demodulation of data symbols at the receiver side. In other words, the receiver may configure itself based on received DMRS, which is used to estimate the respective radio communication channel and to demodulate data symbols received via the respective radio communication channel. In comparison with DMRS Type 2 in which the resource element group in frequency domain includes at least two consecutive resource elements, the minimum resource element group in frequency domain is one resource element in DMRS Type 1. A resource element may refer to the smallest physical unit in time and frequency domain that can be allocated to a user.

An antenna port may be understood as a logical concept representing a specific channel or associated with a specific channel. An antenna port may be understood as a logical structure associated with a respective channel (e.g., a respective channel between a user equipment and a base station). Illustratively, symbols (e.g., OFDM symbols) transmitted over an antenna port (e.g., over a first channel) may be subject to different propagation conditions with respect to other symbols transmitted over another antenna port (e.g., over a second channel). An antenna port may be defined such that the channel over which a symbol on the antenna port is conveyed can be inferred from the channel over which another symbol on the same antenna port is conveyed. In other words, each antenna port may be associated with its own resource grid and a respective set of reference signal in the grid.

TX port assignment may refer to an allocation of multiple antenna ports for transmission of a signal from a transmitter. For a MIMO system, it may include a mapping of data streams to a set of antenna ports. Each port may be associated with a physical antenna of the transmitter. It may include determination of the number of data streams and the mapping of the data streams to multiple physical antennas.

Precoding may refer to a signal processing technique in which an input signal may be multiplied with a precoding matrix to change the phase and/or amplitude of the input signal. In other words, one or more data streams to be transmitted via multiple antennas are transformed by applying different weights (phase and gain) for various reasons such as maximizing the throughput, reducing the effect of interference, etc. Accordingly, radio communication signals transmitted by the antenna correspond to weighed one or more data streams.

For implementation, precoding may include multiplying the input signal which may include one or more data streams with certain weights, which may be provided by multiplying with a precoding matrix including a plurality of weights, which the number of weights depending on the number of data streams and the number of antennas configured to transmit the radio communication signal including the input signal. Each weight may include a complex value. Generally, a processor may determine the precoding matrix based on communication channel conditions for the communication channel between the transmitter and the receiver to which the radio communication signal is to be transmitted. In 5G NR, the processor may determine the precoding matrix based on a precoding matrix indicator.

In more detail and for an example of 4 layers to be transmitted by 4 antennas as depicted in FIG. 4, the input signal may include signals for each layer of 4 layers. Each signal of a layer may include data associated with that layer that is mapped into a data symbol that may have a complex value. The precoder may apply a precoding matrix to data symbols of 4 layers by multiplying the precoding matrix with the data symbols of 4 layers. For a transmission of 4 layers via 4 antennas, each layer may be mapped to the 4 antennas, resulting a 4×1 vector for weighing each layer for 4 antennas. In other words, the precoding matrix may include the combination (i.e. concatenation) of each 4×1 vector for 4 layers. Traditionally, the precoding matrix may be determined based on communication channel properties. The output of the precoder may be referred to as precoded signal. The transmission may further include modulation of precoded signal (i.e. precoded symbols) onto a carrier signal according to a particular modulation scheme.

Mathematically, the multiplication may be denoted with:

$$W \times L = P = [ \begin{matrix}{w}_{1 , 1} & {w}_{1 , 2} & {w}_{1 , 3} & {w}_{1 , 4} \\ {w}_{2 , 1} & {w}_{2 , 2} & {w}_{2 , 3} & {w}_{2 , 4} \\ {w}_{3 , 1} & {w}_{3 , 2} & {w}_{3 , 3} & {w}_{3 , 4} \\ {w}_{4 , 1} & {w}_{4 , 2} & {w}_{4 , 3} & {w}_{4 , 4}\end{matrix} ] \times [ \begin{matrix}{l}_{1} \\ {l}_{2} \\ {l}_{3} \\ {l}_{4}\end{matrix} ] = [ \begin{matrix}{o}_{1} \\ {o}_{2} \\ {o}_{3} \\ {o}_{4}\end{matrix} ]$$

L representing an input of a precoder may include a data symbol for each layer, 4 data symbols l1, l2, l3, l4, which may be represented with a matrix of 4×1; W representing the precoding matrix including 16 weight coefficients (wᵢⱼ) i=1, 2, 3, 4; j=1, 2, 3, 4; and P representing the precoded outputs (o1, o2, o3, o4) corresponding to weighed symbols of 4 streams that may be transmitted by 4 antennas. Portions of the precoding matrix W may be denoted as W(:, 0:1) representing the first two columns of the precoding matrix W, and as W(:, 2:3) representing the last two columns of the precoding matrix W.

1. A wireless communication device comprising:
a transmitter; and
a processor coupled to the transmitter, wherein the processor is configured to:
determine a first signal corresponding to a resource block group;
determine a phase shift;
shift a second signal by the phase shift; and
control the transmitter to transmit the first signal and the phase shifted second signal during a transmission time corresponding to the resource block group.

2. The wireless communication device of claim 1, wherein the first signal comprises a first reference symbol and the second symbol comprises a second reference symbol.

3. The wireless communication device of claim 2, wherein the first reference symbol has a symbol number with a transmission frame, and wherein the second reference symbol has a same symbol number within the transmission frame as the first reference symbol.

4. The wireless communication device of claim 1, wherein the processor is further configured to determine a first precoding matrix, and precode the first signal according to the first precoding matrix.

5. The wireless communication device of claim 4, wherein the processor is further configured to control the transmitter to transmit the first signal by controlling the transmitter to transmit the precoded first signal.

6. The wireless communication device of claim 1, wherein the processor is further configured to determine a second precoding matrix, wherein the second precoding matrix is configured to shift the second signal by the phase shift when the second signal is precoded according to the second precoding matrix; and wherein shifting the second signal by the phase shift and controlling the transmitter to transmit the phase shifted second signal comprises precoding the second signal by the second precoding matrix and controlling the transmitter to transmit the precoded second signal.

7. The wireless communication device of claim 1, wherein the processor is configured to operate according to a code division multiplexing scheme.

8. The wireless communication device of claim 1, wherein the first reference symbol and the second reference symbol are symbols for a Demodulation Reference Signal.

9. The wireless communication device of claim 1, wherein the first signal and the second signal are signals according to the according to the 3rd Generation Partnership Project (3GPP), New Radio, Release 15.

10. The wireless communication device of claim 1, wherein the first reference symbol is assigned a first transmission time according to the 3rd Generation Partnership Project (3GPP), New Radio, Release 15 (3GPP Rel. 15) scheme; wherein the second reference symbol is assigned a second transmission time according to the 3GPP Rel. 15; and wherein the first transmission time and the second transmission time are concurrent.

11. The wireless communication device of claim 1, wherein the resource block group is a first resource block group;
wherein the phase shift is a first phase shift; and
wherein the processor is further configured to:
determine a third signal corresponding to a second resource block group, adjacent to the first resource block group, wherein the third signal comprises a further reference symbol;
determine a second phase shift, different from the first phase shift;
shift a fourth signal comprising the further reference symbol by the second phase shift; and
control the transmitter to transmit the third signal and the phase shifted fourth signal during the transmission time corresponding to the second resource block group.

12. The wireless communication device of claim 11, wherein the processor is further configured to shift at least one of the second signal or the fourth signal by applying physical resource group specific weights during precoding.

13. The wireless communication device of claim 11, wherein the processor is further configured to determine the first phase shift by determining a first constant phase shift for the first resource block group, and wherein the processor determining the second phase shift comprises the processor determining a second constant phase shift, different from the first constant phase shift, for the second resource block group.

14. The wireless communication device of claim 11, further comprising a precoder, configured to receive a signal, apply one or more precoding weights to the signal, and output a precoded signal as the signal to which the precoding weights were applied;
wherein the processor is configured to shift at least one of the second signal or the fourth signal by controlling the precoder to apply physical resource group specific weights during precoding.

15. The wireless communication device of claim 1, wherein the resource block group comprises a plurality of subcarriers, and wherein the processor is configured to control the transmitter to transmit data on each subcarrier of the plurality of subcarriers in the resource block group according to the determined phase shift.

16. The wireless communication device of claim 1, wherein the second signal corresponds to the resource block group.

17. (canceled)

18. (canceled)

19. (canceled)

20. A non-transitory computer readable medium, comprising instructions which, if executed, cause a processor to:
determine a first signal corresponding to a resource block group;
determine a phase shift;
shift a second signal by the phase shift; and
control a transmitter to transmit the first signal and the phase shifted second signal during a transmission time corresponding to the resource block group.

21. The non-transitory computer readable medium of claim 20, wherein the first signal comprises a first reference symbol and the second symbol comprises a second reference symbol.

22. (canceled)

23. (canceled)

24. A wireless communication device comprising:
a processor, configured to:
determine a first signal corresponding to a resource block group;
determine a first precoding matrix for the first signal;
precode the first signal according to the first precoding matrix;
determine a second signal corresponding to the resource block group;
determine a second precoding matrix for the second signal;
determine a phase shift;
modify the second precoding matrix by values representing the phase shift;
precode the second signal according to the modified second precoding matrix; and
control a transmitter to transmit the precoded first signal and the precoded second signal.

25. The wireless communication device of claim 24, wherein the processor is further configured to cause to transmitter to transmit a sum of the precoded first signal and the precoded second signal.
